(19) United States
(12) Patent Application Publication
(10) Pub. No.: US 2017/0039792 A1
(43) Pub. Date: Feb. 9, 2017

(54) System And Method For Identifying And Exporting Cast Vote Record Data

(71) Applicant: Hart InterCivic Inc., Austin, TX (US)

(72) Inventors: Edward P. Perez, Austin, TX (US); Drew E. Tinney, Austin, TX (US)

(21) Appl. No.: 14/817,317

(22) Filed: Aug. 4, 2015

(51) Int. Cl. G07C 13/00

(52) U.S. Cl. CPC G07C 13/00

(57) ABSTRACT

A technique for generating and utilizing improved electronic cast vote records is described. In one embodiment, electronic cast vote records are provided that include more than just ballot content data. For example, electronic cast vote records are provided that include process workflow and/or deployment related data in addition to the ballot content. In such an embodiment, the cast vote records may include both ballot content data and workflow and/or deployment related data. In another embodiment, the systems described herein allow for filtering, exporting, auditing, etc. electronic cast vote records according to workflow and/or deployment variable data in addition to ballot content data.

### BACKGROUND OF THE INVENTION

The present disclosure relates to the voting systems for elections. More specifically, it provides a system and method for managing computerized ballot processing and vote tabulation processes.

A variety of electronic voting systems are well known. Such systems include, for example, paper ballot systems in which ballots are scanned for electronic tabulation and direct recording electronic (DRE) voting systems that record votes directly. Electronic voting systems typically include an electronic cast vote record. As used herein, an electronic cast vote record is an electronic record that indicates the determined voter's choice or selection in a manner determined in accordance with the voting system. Thus, an electronic cast vote record is an electronic record of a voter's cast ballot and may be used in the vote tabulation process. Typically, the electronic cast vote record also serves as an archival record of the votes produced by a voter. Discussion: Cast vote records may be in electronic, paper or other form. Electronic cast vote records are also called ballot images] The electronic cast vote record may originate from either a DRE vote or a paper ballot. Typically, an electronic cast vote record may be retained for archival records and audit purposes in addition to use for tabulation purposes. In the case of a paper ballot, a ballot image may be obtained from paper ballot. As used herein, a “ballot image” image refers to the image of the ballot and any associated affiliated data before the final determination of a voter's selections or choices are established and logged. A ballot image may be converted to a cast vote record when the final determination of a voter's selections or choices is established and recorded as the electronic cast vote record.

As known in the art, ballot images and cast vote records may include ballot content data such as data that reflects a voter's selections and choices in an election. Ballot images may include data associated with the ballot contents and other data such as an electronic image of the ballot itself. However, cast vote records typically only include ballot content data. Thus, known electronic cast vote records may include data such as precinct, polling place, party, voting contents (user's selections, choices, write-in, blank, etc.), ballot type, and ballot identifier. The limited data available in association with the cast vote record may be used to filter the cast vote record as part of the creation of tabulation reports, auditing, etc. as is known in the art. It is desirable to utilize improved electronic cast vote records and to provide for additional usage of such improved cast vote records.

### SUMMARY OF THE INVENTION

The present disclosure provides a technique for generating and utilizing improved electronic cast vote records. In one embodiment, electronic cast vote records are provided that include more than just ballot content data. For example, electronic cast vote records are provided that include process workflow and/or deployment related data in addition to the ballot content. In such an embodiment, the electronic cast vote records may include both ballot content data and workflow and/or deployment related data. In another embodiment, the systems described herein allow for filtering, exporting, auditing, etc. electronic cast vote records according to workflow and/or deployment variable data in addition to ballot content data. In this manner, reports and audits may be more customizable, granular, and useful as compared to reports and audits that merely rely on ballot content data. Further, the various workflow and deployment variables may be user defined, providing further customization and usefulness in the analysis of a electronic cast vote record.

The types of workflow and/or deployment variables that may be associated with the cast vote record are wide ranging. The techniques described herein are not meant to be limited to a particular class or type of workflow and/or deployment variable. Such variables may include, for example, scanner number/scanner identification information, scanning batch number, voting device type (for example digital in person scanner, DRE device, centralized batch scanner, etc.), voting device number/device identification information, memory device type, memory device number/device identification information, software name and version, firmware version, batch transmission identifier, cast vote record transmission time/date, transmission session identifiers, ballot resolution information (for example the ballot had a discrepancy that was resolved automatically by the system, resolved via elections office intervention, etc.), any other device numbers or IDs, etc.

In one embodiment a method of configuring an election voting system is disclosed. The method may include providing one or more election devices to process a voter's ballot selections and configuring the one or more election devices to collect both ballot content information and workflow and/or deployment data. The method may further include configuring the election devices to generate an electronic cast vote record based upon voter ballot selections, the electronic cast vote record including both ballot content information and workflow and/or deployment data. The workflow and/or deployment data may include workflow or deployment data regarding the election devices, the processing of the voter's ballot selections, or the processing of the electronic cast vote record. The method may further include configuring a computer system to utilize the electronic cast vote record as part of tabulation of an election result and configuring the computer system to allow for filtering, auditing, reporting, or analyzing the electronic cast vote records based upon the workflow and/or deployment data.

In another embodiment, a method of operating an election voting system is disclosed. The method may include obtaining ballot content information that includes voter's vote selection data, collecting workflow and/or deployment data regarding (1) the equipment used to obtain the voter's vote selection data or (2) a process used to obtain the voter's vote selection data. The method may further include converting the ballot content information into an electronic cast vote record, the electronic cast vote record including both the ballot content information and the workflow and/or deployment data. The method may further include utilizing the electronic cast vote record to tabulate an election result.

In yet another embodiment, an election voting system is disclosed. The system may include a voting sub-system, the voting system recording a voter's vote selections. The system may further include an electronic cast vote record created by the voting sub-system, the electronic cast vote record being a record of the votes produced by a voter, the electronic cast vote record utilized during tabulation of an election. The electronic cast vote record may include both (1) ballot content data and (2) workflow and/or deployment data, the workflow and/or deployment data being workflow and/or deployment data regarding the voting sub-system and/or the electronic cast vote record. The system may further include a central elections office computer system configured to receive the electronic cast vote record created by the voting device sub-system. The computer system may allow the electronic cast vote records to be filtered, audited and/or analyzed based upon at least the workflow and/or deployment data. In one embodiment the voting sub-system may include paper ballot voting equipment. In another embodiment, the voting subsystem may include at least one direct recording electronic voting device.

### BRIEF DESCRIPTION OF THE DRAWINGS

A more complete understanding of the present invention and advantages thereof may be acquired by referring to the following description taken in conjunction with the accompanying drawings, in which like reference numbers indicate like features. It is to be noted, however, that the accompanying drawings illustrate only exemplary embodiments of the disclosed concept and are therefore not to be considered limiting of its scope, for the disclosed concept may admit to other equally effective embodiments.

FIG. 1 illustrates an exemplary process flow of a voting system utilizing at least some of the techniques disclosed herein.

FIG. 2 illustrates an exemplary hardware configuration for a voting system utilizing at least some of the techniques disclosed herein.

### DESCRIPTION OF THE PREFERRED EMBODIMENTS

The present disclosure provides a technique for generating and utilizing improved electronic cast vote records. In one embodiment, electronic cast vote records are provided that include more than just ballot content data. For example, electronic cast vote records are provided that include process workflow and/or deployment related data in addition to the ballot content. In such an embodiment, the electronic cast vote records may include both ballot content data and workflow and/or deployment related data. In another embodiment, the systems described herein allow for filtering, exporting, auditing, etc. electronic cast vote records according to workflow and/or deployment variable data in addition to ballot content data. In this manner, reports and audits may be more customizable, granular, and useful as compared to reports and audits that merely rely on ballot content data. Further, the various workflow and deployment variables may be user defined, providing further customization and usefulness in the analysis of an electronic cast vote record.

The types of workflow and/or deployment variables that may be associated with the cast vote record are wide ranging. The techniques described herein are not meant to be limited to a particular class or type of workflow and/or deployment variable. Such variables may include, for example, scanner number/scanner identification information, scanning batch number, voting device type (for example digital in person scanner, DRE device, centralized batch scanner, etc.), voting device number/device identification information, memory device type, memory device number/device identification information, software name and version, firmware version, batch transmission identifier, cast vote record transmission time/date, transmission session identifiers, ballot resolution information (for example ballot had a discrepancy that was resolved automatically be the system, resolved via elections office intervention, etc.), etc.

It will be recognized that the potential workflow and/or deployment variables for inclusion with the electronic cast vote record will vary depending upon the systems and techniques used to conduct any particular election. Thus, such variables will depend upon the various voting systems used in a particular jurisdiction and the particular election codes governing an election. Further, the variables that may be associated with the electronic cast vote record may depend upon the particular hardware and software configurations utilized to conduct an election, including the systems used to provide a ballot to a voter, collect a voter's selections and choices, and process/tabulate votes. Thus, though exemplary workflow and/or deployment variables are described herein, it will be recognized that a wide range of other particular workflow and/or deployment variables may be utilized in conjunction with the techniques described herein.

The electronic voting system may utilize the concepts described herein in a variety electronic election voting sub-systems such as paper ballot imaging sub-systems, DRE sub-systems, and sub-systems for the generation of electronic cast voter records. Further, the electronic vote record techniques may be utilized with a variety of other voting system sub-systems, in combination or separately, all of which would be recognized by one skilled in the art having the benefit of this disclosure.

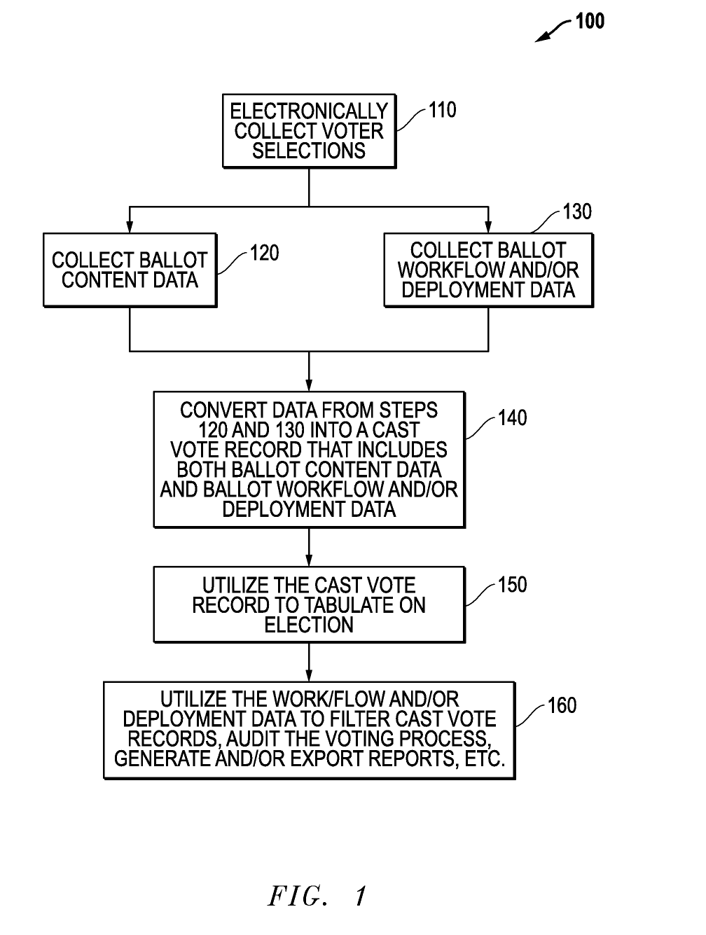

FIG. 1 illustrates an exemplary process flow 100 for one embodiment of an election vote process which may utilize the concepts disclosed herein. As shown in FIG. 1, at step 110 voter selections may be electronically collected. Such voter selections may be obtained by scanning paper ballots (for example ballots having voter choice indicia printed at a polling place, mail-in ballots or absentee ballots). Such voter selections may also be obtained by use of DRE equipment or any other method or device as known in the art. Independent of which techniques are utilized to obtain voter selection information, at step 120 ballot content data is collected. The ballot content data may include, for example, the voter's selections and choices, precinct, polling place, ballot type, contest, ballot ID, etc. In addition, at step 130 data indicative of the workflow and/or deployment of the ballot and voting process may also be collected. Though shown as three separate steps, steps 110, 120, and 130 may be performed together and/or separately, in whole or in part. At step 140, the data from steps 120 and 130 may be converted into a cast vote record. The cast vote record may include both ballot content data and ballot/voting process workflow and/or deployment data. In step 150, the cast vote record may be used to tabulate an election. In step 160, the workflow and/or deployment data within the cast vote record may be utilize to filter the cast vote records, audit the voting process, generate and/or export reports, etc.

Another exemplary process flow for utilizing at last some of the disclosed techniques of one embodiment is next described. In this embodiment voting may be accomplished through the use of either one of or both of DRE voting or a paper ballot voting. The paper ballots may be any of a variety of paper ballot types. For example the paper ballots may be mail-in or absentee ballots provided to a voter. Alternatively, the paper ballots may be generated at a polling location and result from a ballot printed with a voter's electronic voting selections or even manually marked voter selections. In either case, the paper ballot includes indicia of a voter's vote selection.

After the paper ballots are marked with the indicia of a voter's vote selection, the paper ballots may be scanned, either individually or in bulk. Whether the paper ballots are received at a polling place or at a central elections office (such as mail-in and absentee ballots), the scanning of the paper ballots creates electronic paper ballot image files. In addition to ballot content information, the electronic ballot image files may include data regarding a variety of workflow and/or deployment variables. For example, the variables may include data regarding the scanning batch number (if a batch scan), a scan sequence number, date and time of scan, the user who scanned a batch, number of ballots in a batch, any ballot unique identifiers, the scanner number or identifier, a printer number or identifier, the scanner device number or identifier, voting device type, voting device number or identifier, the software and/or firmware versions for any of the devices used to generate, process or scan the ballot, ballot resolution information (for example ballot had a discrepancy that was resolved automatically by the system, resolved via elections officer intervention, etc.), The paper ballot image may also include ballot resolution data indicative of the status of the scanned ballot, such as whether there are voter intent issues or not, whether such issues are resolved or not, resolved automatically or resolved with election officer intervention, etc.

Once the paper ballots have been scanned, the election system may analyze the paper ballot image files to verify validity of the ballot and identify voter marks on the ballot. Such processes are well known in the art and may account for undervotes, overvotes, write-candidates, invalid ballots or any other voter intent issues. When the paper ballot image files have satisfactory processed, the ballot image files and all the collected workflow and/or deployment data may be written as cast vote records. Depending upon the particular election system being utilized, the cast vote records may be recorded on mobile memory devices (for example, memory sticks, portable hard drives, etc.) or may be recorded in other non-mobile memory. According to the techniques disclosed herein, the workflow and/or deployment variables collected and affiliated with the electronic cast vote record may further include the memory type, memory device number or identifier, memory location, etc. at which the electronic cast vote record is electronically written. Furthermore batch transmission identifier, cast vote record transmission time/date, transmission session identifiers, etc. regarding the transmission of the electronic cast vote record (such as to a central elections office) may also be collected and affiliated with the electronic cast vote record. Thus, the electronic collected variables extend to workflow and/or deployment variables regarding the electronic cast vote record itself. In accordance with the techniques disclosed herein, the cast vote records may include some or all workflow and/or deployment variables data described herein. Thus, the cast vote record created from a paper ballot may include not only ballot content information but also workflow and/or deployment variable data regarding the paper ballot and the corresponding cast vote record. The cast vote records may then be used for official vote tabulations, a process typically performed at a central elections office location.

The techniques for utilizing the concepts disclosed herein with regard to DRE voting are similar to that described with regard to the paper ballots. However, in DRE embodiments some of the workflow and/or deployment variables may be different. Thus, exemplary variables that may be collected during a DRE voting process may include voting type, date and time of the vote, voting device type, voting device number or identifier, the software and/or firmware versions for any of the devices used to generate and process the vote, etc. The DRE vote equipment typically generates an electronic cast vote record directly in the DRE device or on another device in communication with the DRE device. As with the paper ballot process, the electronic cast vote record may be written to mobile or non-mobile memory. The workflow and/or deployment variables collected may further include the memory type, memory device number or identifier, memory location, etc. at which the electronic cast vote record is electronically written. Furthermore, transmission information regarding any transmission of the electronic cast vote record between equipment or databases may be collected and affiliated with the cast vote record such as transmission identifier, cast vote record transmission time/date, transmission session identifiers, etc. Thus, the collected variables in a DRE vote also extend to workflow and/or deployment variables regarding the electronic cast vote record itself. In accordance with the techniques disclosed herein, the DRE electronic cast vote records may include some or all workflow and/or deployment variables data described herein. Thus, the electronic cast vote record created from a DRE vote may include not only ballot content information but also workflow and/or deployment variable data regarding both the DRE process/equipment and the corresponding electronic cast vote record itself. The electronic cast vote records may then be used for official vote tabulations, a process typically performed at a central elections office location. The DRE votes may be transmitted to the central elections office location via a memory drive or via direct electronic transmission. In accordance with the techniques disclosed herein, the DRE based cast vote records may include some or all workflow and/or deployment variables data described herein. Thus, the electronic cast vote record created from a DRE ballot includes not only ballot content information but also workflow and/or deployment variable data. The DRE electronic cast vote records may then be used for official vote tabulations, a process typically performed at a central elections office location.

One exemplary paper ballot process flow is described in more detail below. It will be recognized that such a process flow is merely exemplary and many other process flows may be utilized to process paper ballots. According to the techniques described herein, any workflow and/or deployment variables of the process flow may be collected and affiliated with the electronic cast vote record that is eventually created from the processing of the paper ballot. First, mail-in and absentee paper ballots may be received at a central elections office. The paper ballots may be scanned in bulk to capture all voter marks. The ballots may be scanned into digital files and compiled into batches. Each batch may be saved with a unique ID and voting type information. Batch information may also include manually added notes. Once ballots are scanned, the election system may analyze the ballots to verify the validity of the ballot and to identify voter marks on the ballot. The system may flag any potential voter intent issues for review. Voter intent issues may include undervotes, overvotes, write-in candidates, illegible markings, invalid ballots, etc. Each scanning batch may further be given a status indicating if none of the ballots in a batch have a voter intent issue (all resolved) or whether at least one ballot has a voter intent issue (unresolved). Flagged ballots are reviewed for voter intent and resolved. Ballots are then written as electronic cast voter records to memory drives. Each memory drive may hold multiple batches. The memory drives may then be utilized at the central elections office by loading the drives on a central server for official tabulation of the votes via vote tabulation software. The electronic cast vote records may include any of a wide variety of workflow and/or deployment variables as described above. At a precinct, a voter may enter their voting choices in a voting machine and a connected printer may print the paper ballot including the voter's selections. The voter may then input their ballot may into a precinct scanner. If any voter intent issues are detected, the scanner may reject the ballot so that the voter and/or precinct workers may resolve the error. When ballots are accepted by the scanner, the ballot image may be written as an electronic cast vote record into a connected memory drive. The precinct generated electronic cast vote records may include the corresponding workflow and/or deployment variables as described above. The memory drives may subsequently be utilized at the central elections office by loading the drives on a central server for official tabulation of the votes via vote tabulation software. Though the paper ballot processes described above reference the use of memory drives, direct wired or wireless connections may be used to transmit cast vote records to a central elections office tabulation computer.

As will be recognized, the collection of workflow and/or deployment variables may thus be used in election systems that use only paper ballot processing, DRE vote processing or a combination of both. As will also be recognized, the workflow and/or deployment variables collected may be customized based upon an election jurisdiction's rules and desires. The techniques described herein provide a flexible process in which a wide range of data may be collected. The techniques are not limited to the particular workflow and/or deployment variables described herein as such variables are merely exemplary.

The collection of workflow and/or deployment variables and affiliation of that data with electronic cast vote records allows for great flexibility in post tabulation auditing and review of cast vote records. Thus, a user may generate reports and analysis based on a highly selective search capability to identify electronic cast vote records based on a broad list of user selectable variables. A user may also define filters as to various variables to analyze the electronic cast vote records. Thus, selectable variables include not only ballot content data but variables associated with the specific deployment and/or workflow of the voting process. The reports may be output in any variety of formats including human readable reports and machine readable formats. For example, a report could be created that correlates all electronic cast vote records to the particular scanner or DRE machine utilized. Alternatively, reports could correlate the electronic cast vote records to the memory drives utilized. It will be recognized that endless variations of the data created may be utilized as the basis of any given report.

The techniques described herein may be utilized as a final reconciliation tool in addition to exporting un-totaled (i.e. individual) cast vote record data according to user defined classes. Therefore the techniques allow users to verify that a system's mathematical calculations of tabulated totals match other tabulated totals (such as human or machine counted results). Likewise the techniques described herein provide for many options of post-tabulation audits. A user may thus audit electronic cast vote record data based on any of a wide range of data available, including user-defined searches and exporting of data. Thus, customizable audits are available that may be based not only on ballot content data but also upon corresponding workflow and/or deployment data.

In one embodiment, the techniques described herein allow for unique processing of paper ballots. More particularly, filtering, exporting and auditing of data may be performed at both the ballot image stage and the cast vote record stage with the benefit of workflow and/or deployment data at either stage. Included in such techniques is the ability to correlate workflow and/or deployment data between ballot images and electronic cast vote records for reporting, exporting, auditing or discrepancy review purposes. Described below is one such exemplary process for both ballot images and electronic cast vote records. It will be recognized that the process flow and data collected is merely exemplary and described to illustrate the potential use of the techniques described herein. Other process flows and other workflow and/or deployment data may be utilized and collected as would be recognized by one skilled in the art.

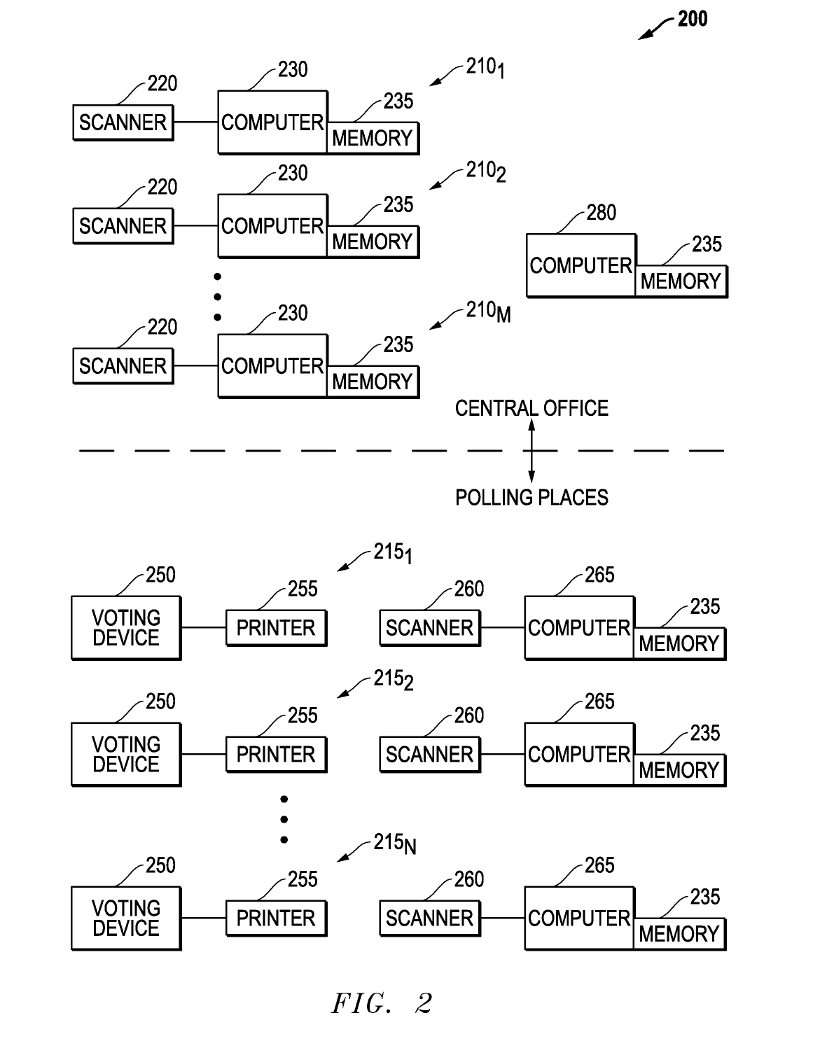

The exemplary ballot image and cast vote record process is illustrated with regard to the voting system 200 of FIG. 2. As shown in FIG. 2, a plurality of high speed scanning voter sub-systems 210₁, 210₂, . . . 210ₘ, may exist. The high speed scanning sub-systems correspond to subsystems located at a central elections office for processing mail-in and absentee paper ballots. In addition, any number of precinct polling voter subsystems 215₁, 215₂, . . . 215ₙ, may exist. The precinct sub-systems may include scanners that scan ballots generated at a precinct polling place. Electronic cast vote records may be created at both the high speed scanning central office locations and the precinct polling locations. The electronic cast vote records may be provided to a central elections office tabulation computer 280 for tabulation of the election.

The high speed scanning sub-systems 210₁, 210₂, . . . 210ₙ located at a central elections office may include a scanner 220 and an attached (directly or wirelessly) computer 230. The scanner 220 and the computer 230 may both be commercial-off-the-shelf products. For example, the scanner 220 may be a standard commercial high speed scanner and the computer 230 may be a personal computer. Ballot imaging and adjudication software may be installed on the computer 230. The scanner 220 and the computer 230 may be attached in any of a wide variety of known ways including wired and wireless connections. For example, the scanner 220 and computer 230 may be attached via a USB connection in one embodiment. Paper ballots may be inserted into the scanner 220 either in individual or batch format. After each ballot is scanned, an image of the ballot may be stored by the ballot imaging and adjudication software of the computer 230. The stored ballot image may include a variety of workflow and/or deployment data in addition to the ballot content information and an image of the ballot itself. For example, the ballot image may include precinct/precinct split name, district party (i.e. in a closed primary), scanning workstation name, voting type, scanning batch ID, ballot serial number range, scanning batch status, the presence of voter intent issues (for example blank ballots, overvotes, undervotes, invalid contests such as cross-party voting in an open primary, voted write-ins) an indicator that the ballot contains one or more unresolved voter intent issues, an indicator that the ballot does not contain any unresolved voter intent issues, an indicator that the ballot contains one or more contests that have been resolved by a user, an indicator that the ballot contains contests that have been resolved by the automatic resolution feature, an indicator that none of the contests have been modified since the ballot was scanned, etc.

For the high speed scanning sub-systems, based on the combination of one or more selected variables, users can view images of selected ballots on-screen using computer 230. Images may be color coded to describe machine processing of marks. Images may also contain plain-language annotations to describe machine processing of marks and/or manual user “overrides.” Users can confirm machine processing of marks, or make manual adjudications to record voter marks differently than the machine processing. Users can “toggle” a graphic overlay to show or hide the adjudication notes and color-coding. Users can create a customized class of user-selected ballots based on one or more of any of the collected ballot content data or the collected workflow and/or deployment data. Within the customized class of user-selected ballots, users can export (as hard copies or electronic files) individual ballot images, with or without the graphic overlay. Within the customized class of user-selected ballots, users can export large quantities of original (i.e. un-annotated) ballot images by batch. In this manner ballot images may be filtered or analyzed based on a wide range of variables including both ballot content data and workflow and/or deployment data. Ultimately adjudicated ballots may be written as cast vote records by computer 230 to a memory drive 235 (for example a mobile memory drive). The memory drive 235 may then be loaded into central elections office tabulation computer 280 for official vote tabulation of the electronic cast vote records. It will be recognized that direct computer connections (wired or wireless) rather than mobile memory drives may be utilized. Further, though computers 230 and 280 are shown as separate computers, some or all of the computers may be formed as one computer system and separate computers are not required.

As further shown in FIG. 2, precinct polling voting sub-systems 215₁, 215₂, . . . 215ₙ may be utilized. The precinct polling voting sub-systems may include one or more voting devices 250 and one or more attached printers 255. In use, a voter may record their votes through the voter device 250 and a printed completed ballot including the voter's election selections is printed on printer 255 when the voter is done voting. The voter may then enter the completed ballot in a scanner 260. Scanner 260 may be coupled to a precinct computer 265. If the ballot is acceptable (no voter intent issues or other errors), the scanned ballot may be converted to a cast vote record and written to the attached memory drive 235. The cast vote record may include both ballot content and workflow and/or deployment data such as described above with regard to the high speed scanner process (further including any precinct specific workflow and/or deployment data related to the computer 250, printer 255, scanner 260, computer 265 and memory drive 235). It will be recognized that alternatively voting devices at the precinct polling location that write an electronic cast vote record to a memory drive 235 (directly or through a precinct computer 265) may also be utilized. In this alternative, a printer 255, a printed ballot, and scanner 260 may not be utilized.

Whether the electronic cast vote record is created at a central elections office or a precinct polling location, the electronic cast vote record may then be transmitted to central elections office tabulation computer 280. The cast vote record may be transmitted by loading the mobile memory drives 235 (removed from computers 230 and 265) into the tabulation computer 280. As mentioned, it will be recognized that alternatively electronic cast vote records may be transmitted to the tabulation computer via wireless or wired connections such as through a private network, the Internet or other electrical or wireless connections. The tabulation computer 280 may be, in one embodiment, a commercial off the shelf personal computer workstation. In yet another embodiment, the central elections office tabulation computer 280 and the computers 230 may be implemented as one computer system.

After the tabulation computer 280 receives the cast vote record data, a user may select a tabulation option user interface in the tabulation and reporting software installed on the tabulation computer 280 to tabulate the vote results. The tabulation computer may further include an audit option user interface. Using the audit option, users may filter or review electronic cast vote records by selecting one or more of the ballot content and workflow and/or deployment variables from the software user interface. The software thus allows many customized permutations of selected variables. The variables that may be selected include, but are not limited to, polling place, centralized scanning workstation name, centralized scanning batch number, precinct, district, contest, voting device type, digital in-person scanner ID and/or type, DRE device ID and/or type, high-speed centralized scanner, any other device serial numbers or ID numbers, flash memory drive serial number or ID number, voting type, transmission information (date, time, transmission batch, etc.), etc.

Based on the combination of one or more selected variables, users can export electronic cast vote record data from the user-defined class of results. Data can be exported in human-readable format, as a report (either a continuous report, or one cast vote record per page). Data can also be exported as raw data in XML format that can be reviewed by third-parties, without being dependent on proprietary software. Exported electronic cast vote record data may be reviewed in conjunction with ballot images. Also electronic cast vote record data may be used with tabulated results reports utilizing user-defined class of votes, including workflow and/or deployment variables. In this manner, user-defined searches of ballot images and electronic cast vote records according to a long list of workflow and/or deployment variables may be utilized. Thus, for example, ballot images may be exported in accordance with user defined classes of data that are affiliated with the electronic cast vote record. Further, customizable reports of such data may be obtained. Such reports may be used for a variety of audit and analysis purposes. Such reports may also be used to allow users to verify that a voting systems tabulated vote totals match any automated or human counted vote results based on exported cast vote records.

It will be recognized that the hardware configurations described herein are merely exemplary and the techniques disclosed herein may be used by a wide range of hardware configurations. Thus, the hardware configurations illustrated and described herein for central elections offices and precinct polling locations are merely exemplary.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as presently preferred embodiments. Equivalent elements may be substituted for those illustrated and describe herein and certain features of the invention may be utilized independently of the use of other features, all as would be apparent to one skilled in the art after having the benefit of this description of the invention.

What is claimed is:

1. A method of configuring an election voting system, comprising:
providing one or more election devices to process a voter's ballot selections;
configuring the one or more election devices to collect both ballot content information and workflow and/or deployment data;
configuring the election devices to generate an electronic cast vote record based upon voter ballot selections, the electronic cast vote record including both ballot content information and workflow and/or deployment data, the workflow and/or deployment data including workflow or deployment data regarding the election devices, the processing of the voter's ballot selections, or the processing of the electronic cast vote record;
configuring a computer system to utilize the electronic cast vote record as part of tabulation of an election result; and
configuring the computer system to allow for filtering, auditing, reporting, or analyzing the electronic cast vote records based upon the workflow and/or deployment data.

2. The method of claim 1, wherein the one or more election devices comprise one or more devices for processing paper ballots.

3. The method of claim 2, wherein the electronic cast vote record is configured to include an electronic image of a paper ballot that has indicia of the voter's vote selections.

4. The method of claim 3, wherein the computer is configured so that the filtering, auditing, reporting, or analyzing the electronic cast vote records based upon the workflow and/or deployment data may include providing the electronic image of the completed paper ballot.

5. The method of claim 1, wherein the workflow and/or deployment data contained in the cast vote record includes at least one of scanner number, scanner identification information, scanning batch number, voting device type, voting device number or device identification information, memory device type, memory device number or device identification information, software name or version, firmware version, batch transmission identifier, cast vote record transmission time or date, cast vote record transmission session identifiers, other device numbers or other device identifiers.

6. The method of claim 5, wherein the one or more election devices comprise one or more devices for processing paper ballots.

7. The method of claim 1, wherein the computer system is configured to allow an elections official to verify the voting system's tabulated vote totals based on electronic cast vote records that are filtered by at least one workflow and/or deployment data variable.

8. A method of operating an election voting system, comprising:
obtaining ballot content information that includes voter's vote selection data;
collecting workflow and/or deployment data regarding (1) the equipment used to obtain the voter's vote selection data or (2) a process used to obtain the voter's vote selection data;
converting the ballot content information into an electronic cast vote record, the electronic cast vote record including both the ballot content information and the workflow and/or deployment data; and
utilizing the electronic cast vote record to tabulate an election result.

9. The method of claim 8, wherein the workflow and/or deployment data further includes workflow and/or deployment data regarding the electronic cast vote record.

10. The method of claim 8, wherein the workflow and/or deployment data contained in the cast vote record includes at least one of scanner number, scanner identification information, scanning batch number, voting device type, voting device number or device identification information, memory device type, memory device number or device identification information, software name or version, firmware version, batch transmission identifier, cast vote record transmission time or date, cast vote record transmission session identifiers, other device numbers or other device identifiers.

11. The method of claim 8, wherein the workflow and/or deployment data is utilized to filter, audit or analyze the electronic cast vote records.

12. The method of claim 8, wherein the workflow and/or deployment data is utilized to verify an election tabulated vote result.

13. An election voting system, comprising:
a voting sub-system, the voting system recording a voter's vote selections;
an electronic cast vote record created by the voting sub-system, the electronic cast vote record being a record of the votes produced by a voter, the electronic cast vote record utilized during tabulation of an election, the electronic cast vote record including both (1) ballot content data and (2) workflow and/or deployment data, the workflow and/or deployment data being workflow and/or deployment data regarding the voting sub-system and/or the electronic cast vote record; and
a central elections office computer system configured to receive the electronic cast vote record created by the voting device sub-system, the computer system allowing the electronic cast vote records to be filtered, audited and/or analyzed based upon at least the workflow and/or deployment data.

14. The election voting system of claim 13, wherein the voting sub-system comprises at least one paper ballot voting sub-system, the paper ballot voting sub-system including at least a paper ballot scanner and an associated computer coupled to the scanner.

15. The election voting system of claim 14, the electronic cast vote record including an electronic image of a paper ballot having indicia of the voter's vote selections.

16. The election voting system of claim 14, the associated computer and the central elections office computer being the same computer.

17. The election voting system of claim 13, wherein the voting sub-system comprises at least one direct recording electronic device.

18. The election voting system of claim 13, the central elections office computer receiving the electronic cast vote record via a memory device that is transportable between the voting sub-system and the central elections office computer.

19. The election voting system of claim 13, the central elections office computer receiving the electronic cast vote record via a wired or wireless connection between the voting sub-system and the central elections office computer.

20. The election voting system of claim 13, wherein the workflow and/or deployment data contained in the cast vote record includes at least one of scanner number, scanner identification information, scanning batch number, voting device type, voting device number or device identification information, memory device type, memory device number or device identification information, software name or version, firmware version, batch transmission identifier, cast vote record transmission time or date, cast vote record transmission session identifiers, other device numbers or other device identifiers.

21. The election voting system of claim 13, the central elections office computer system configured to tabulate an election.
